(19) United States
(12) Patent Application Publication
(10) Pub. No.: US 2024/0359147 A1
(43) Pub. Date: Oct. 31, 2024

(54) BLEACH DILUTION AND DELIVERY VEHICLE

(71) Applicants: Timothy F. Maegly, Trinity, FL (US); Julio C. Esis, Medina, OH (US)

(72) Inventors: Timothy F. Maegly, Trinity, FL (US); Julio C. Esis, Medina, OH (US)

(73) Assignee: BleachTech LLC, Seville, OH (US)

(21) Appl. No.: 18/307,136

(22) Filed: Apr. 26, 2023

(51) Int. Cl. B01F 23/40; B01F 23/70; B01F 33/502; B01F 35/21; B01F 35/221; B01F 35/83; G05B 15/02; G05D 11/13

(52) U.S. Cl. CPC B01F 23/483; B01F 23/49; B01F 23/708; B01F 33/5021; B01F 33/5023; B01F 35/2111; B01F 35/2218; B01F 35/83; G05B 15/02; G05D 11/138; B01F 2101/48; B01F 2215/044

(57) ABSTRACT

Bleach dilution and delivery vehicles are enabled. For example, a method can comprise: transporting, using a bleach dilution and delivery vehicle, sodium hypochlorite from a first location to a second location, mixing, using the bleach dilution and delivery vehicle, water from the second location and sodium hypochlorite from the bleach dilution and delivery vehicle to a defined strength, resulting in a diluted mix, and dispensing, using the bleach dilution and delivery vehicle, the diluted mix to the second location.

### TECHNICAL FIELD

The disclosed subject matter relates to vehicles and, more particularly, to vehicles that facilitate at-destination dilution of a water-based acid, base, or other chemicals.

### BACKGROUND

When an entity needs sodium hypochlorite (e.g., bleach), it typically orders the bleach for delivery in a desired concentration (e.g., concentration by volume or weight of sodium hypochlorite). Such concentrations of bleach typically range from approximately 10% to approximately 16%. In order to fulfill a bleach order, a manufacturing entity typically dilutes the bleach to the desired concentration, pumps the diluted bleach (e.g., diluted mix) at the desired concentration onto a delivery vehicle, and sends the delivery vehicle to the entity in the diluted form. However, with rising transportation costs and a diminishing pool of available drivers, it is becoming increasingly inefficient to transport pre-diluted bleach to an entity location.

The above-described background relating to water-based acid or base delivery is merely intended to provide a contextual overview of some current issues and is not intended to be exhaustive. Other contextual information may become further apparent upon review of the following detailed description.

### BRIEF DESCRIPTION OF DRAWINGS

FIG. 1 is a diagram of an exemplary vehicle in accordance with one or more embodiments described herein.

FIG. 2 is a diagram of an exemplary vehicle in accordance with one or more embodiments described herein.

FIG. 3 is a block diagram of an exemplary water treatment system in accordance with one or more embodiments described herein.

FIG. 4 is a block diagram of an exemplary mixing system in accordance with one or more embodiments described herein.

FIG. 5 is a block diagram of exemplary sensor(s) in accordance with one or more embodiments described herein.

FIG. 6 is a block diagram of an exemplary controller in accordance with one or more embodiments described herein.

FIG. 7 illustrates an exemplary scenario associated with water-based acid or base delivery and dilution using a bleach dilution and delivery vehicle in accordance with one or more embodiments described herein.

FIG. 8 is a flowchart of a process associated with bleach dilution and delivery using a bleach dilution and delivery vehicle in accordance with one or more embodiments described herein.

FIG. 9 is piping and instrumentation diagram associated with bleach dilution and delivery using a bleach dilution and delivery vehicle in accordance with one or more embodiments described herein.

FIG. 10 is a block flow diagram for a process associated with bleach dilution and delivery using a bleach dilution and delivery vehicle in accordance with one or more embodiments described herein.

FIG. 11 is a block flow diagram for a process associated with bleach dilution and delivery using a bleach dilution and delivery vehicle in accordance with one or more embodiments described herein.

FIG. 12 is an example, non-limiting computing environment in which one or more embodiments described herein can be implemented.

FIG. 13 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As alluded to above, water-based acid, base, or other chemical delivery can be improved in various ways, and various embodiments are described herein to this end and/or other ends.

According to an embodiment, a bleach dilution and delivery vehicle can comprise: a vehicle, and a mixer affixed to the vehicle that mixes water and sodium hypochlorite to a defined strength, resulting in a diluted mix.

In another embodiment, a method can comprise: transporting, using a bleach dilution and delivery vehicle, sodium hypochlorite from a first location to a second location, mixing, using the bleach dilution and delivery vehicle, water from the second location and sodium hypochlorite from the bleach dilution and delivery vehicle to a defined strength, resulting in a diluted mix, and dispensing, using the bleach dilution and delivery vehicle, the diluted mix to the second location.

According to yet another embodiment, a non-transitory machine-readable medium can comprise executable instructions that, when executed by a processor, facilitate performance of operations, comprising: based on a strength of sodium hypochlorite stored on a bleach dilution and delivery vehicle and a defined output strength, determining a mixing ratio of the sodium hypochlorite and water, and based on the mixing ratio, controlling a mixer of the bleach dilution and delivery vehicle to mix the water and the sodium hypochlorite to the defined output strength.

It should be appreciated that additional manifestations, configurations, implementations, protocols, etc. can be utilized in connection with the following components described herein or different/additional components as would be appreciated by one skilled in the art.

It is noted that though various embodiments herein describe bleach/sodium hypochlorite dilution and/or delivery vehicles, components, or methods, such embodiments are not limited to bleach or sodium hypochlorite. Rather, embodiments herein are applicable to any water-based acid or base that can be diluted. For example, embodiments herein can be applicable to sodium hydroxide or other suitable acids or bases.

Embodiments herein can increase efficiencies associated with the transportation of bleach (e.g., or another suitable concentrate of an acid or base) to an entity location, for instance, by enabling concentrate dilution after transportation, rather than before. By diluting bleach at a destination location, rather than at an origination location, more diluted mix can be provided using a given delivery vehicle or tank size. For example, by diluting a 25% concentration (or another suitable concentration) of bleach at a destination location using a bleach dilution and delivery vehicle herein, approximately twice the end product (e.g., diluted mix) can be provided using the same size tank, as opposed to delivering a pre-diluted 12.5% concentration (or another suitable concentration) of bleach (e.g., diluted mix) to the destination location.

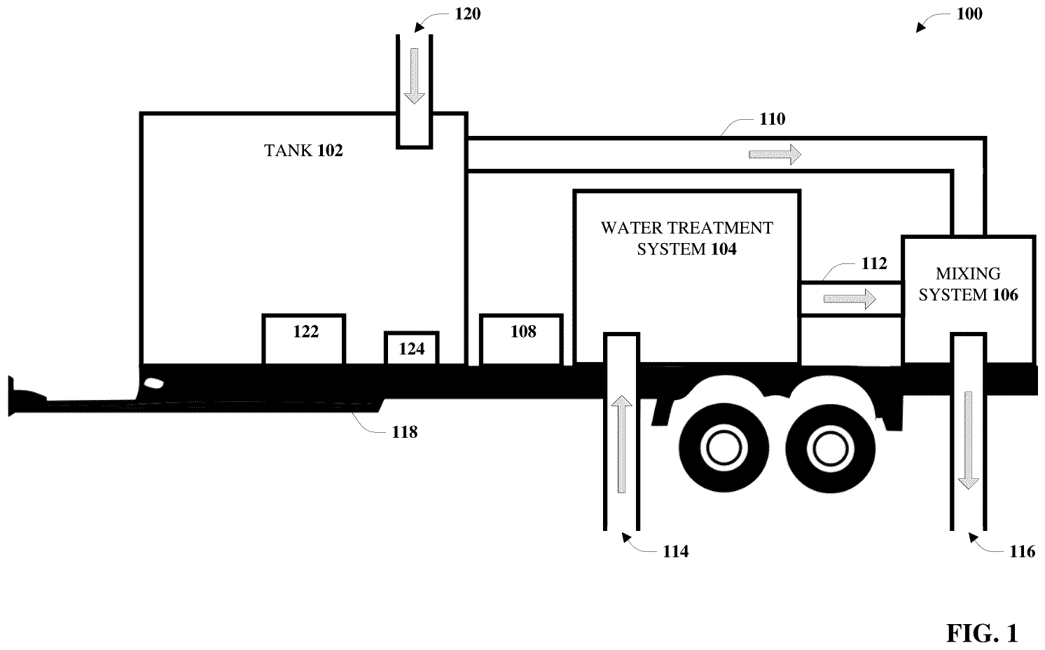

Turning now to FIG. 1, there is illustrated an example, non-limiting bleach dilution and delivery vehicle 100 in accordance with one or more embodiments herein. The bleach dilution and delivery vehicle 100 can comprise one or more of a variety of components, such as tank 102, water treatment system 104, mixing system 106, controller 108, pipe 110, pipe 112, water inlet 114, diluted mix outlet 116, trailer 118, inlet 120, temperature control unit 122, pump 124, and/or other suitable components.

According to an embodiment, bleach dilution and delivery vehicle 100 can comprise a trailer 118. The trailer 118 can comprise an unpowered vehicle that can be towed by a powered vehicle (e.g., a truck). The trailer 118 can comprise one or more of a variety of trailer types, such as a single axle trailer, double axle trailer, triple axle trailer, quad axle trailer, etc. The trailer 118 can comprise one or more of a variety of suspension types, such as a leaf spring suspension, torsion suspension, air suspension, or another suitable suspension type. In various embodiments, the trailer 118 can comprise trailer brakes (e.g., surge brakes or electric brakes) that can assist in slowing or stopping the trailer 118. The trailer 118 can comprise one or more of a variety of materials, such as a metal (e.g., steel, aluminum, stainless steel, or another suitable metal), wood, composite materials, or other suitable material and/or a combination thereof. In various implementations, the trailer 118 can comprise a protective coating (e.g., a corrosion resistant coating) to prevent damage from contact with materials transported by the trailer 118 and/or from road debris or environmental conditions.

One or more of a variety of components suitable for bleach dilution and delivery herein can be mounted to and/or comprised by the trailer 118. For instance, a tank 102 can be mounted on the trailer 118. The tank 102 can be configured to store concentrated bleach (e.g., at a concentration of 25% or higher by weight or volume, though the tank 102 can additionally or alternatively store concentrations lower than 25%) or other suitable acids or bases. For example, the concentrated bleach can comprise a concentration of 5%-35%, or another suitable concentration. The tank 102 can comprise one or more of a variety of materials such as plastics or metals, combinations thereof, or other suitable materials. In some embodiments, the tank 102 can comprise a protective liner to protect the tank 102 from corrosive contents. In other embodiments, the tank 102 can comprise a protective coating (e.g., a corrosion resistant coating) to prevent damage from contact with materials transported in the tank 102.

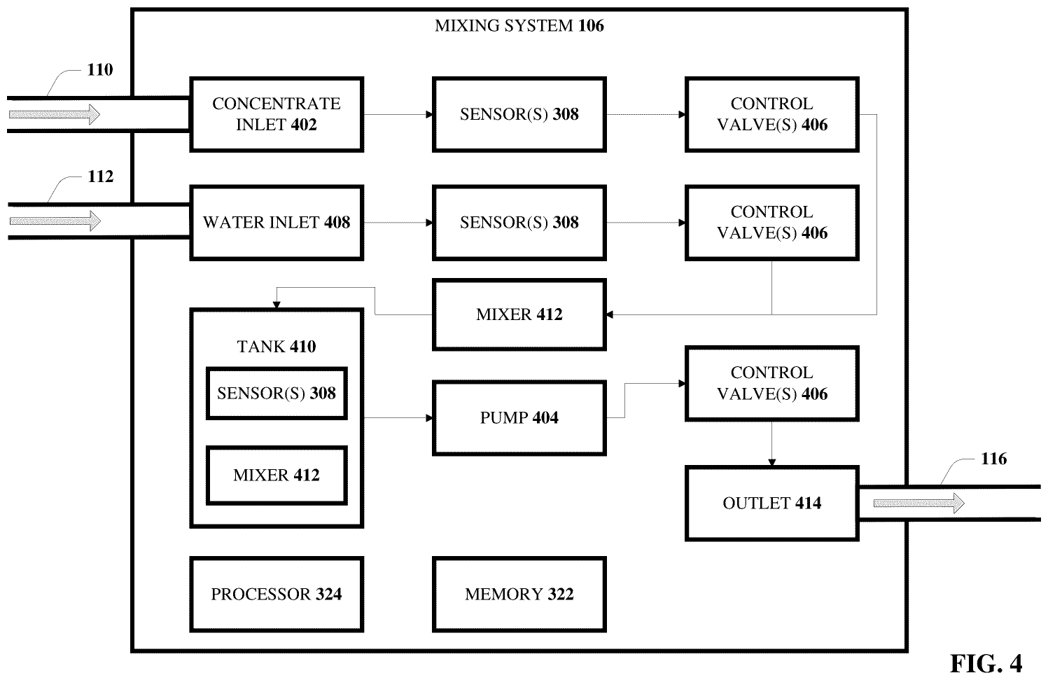

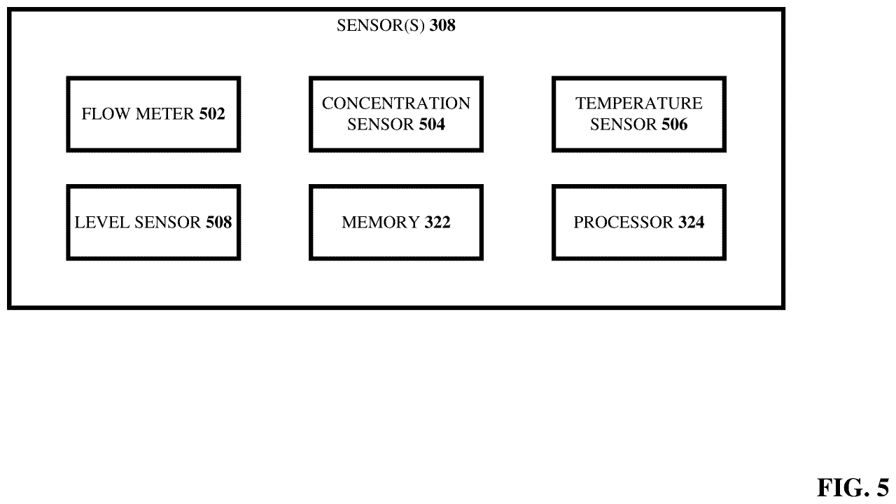

In further embodiments, the tank 102 can comprise a temperature control unit 122 (e.g., heater and/or a cooler) that can be utilized to adjust a temperature of contents of the tank 102 (e.g., controllable via a controller 108 later described in greater detail). In various embodiments, the temperature control unit 122 can comprise a heating coil that can be utilized to heat the contents of the tank 102. In further embodiments, the temperature control unit 122 can comprise a thermoelectric chiller that can be utilized to cool the contents of the tank 102. In this regard, the temperature control unit 122 can be utilized to maintain a defined temperature or temperature range of contents of the tank 102. Maintaining such a defined temperature or temperature range can promote stability of contents of the tank 102. It is noted that the tank 102 can comprise and/or be fluidly connected to the inlet 120. The inlet 120 can be located on any suitable part of the tank 102, and can comprise a fill location at which the tank 102 can be filled (e.g., with the concentrated bleach or another suitable acid or base). In various embodiments, the inlet 120 can comprise a removable cap, funnel, and/or threaded fitting that can enable filling of the tank 102 without spilling of liquids. It is noted that the tank can comprise one or more of a variety of sensor(s) 308 (later discussed in greater detail with respect to FIG. 5), such as a level sensor 508 which can be utilized to determine a level of the liquid in the tank 102 and/or a temperature sensor 506 which can determine a temperature of the liquid in the tank 102. In various embodiments, the tank 102 can be fluidly connected to the mixing system 106 (e.g., a mixer) via the pipe 110. In some embodiments, the pipe 110 can comprise one or more of sensor(s) 308, such as a flow meter 502, which can be utilized to measure flow of the concentrated bleach to the mixing system 106 (later discussed in greater detail with respect to FIG. 4). Further, the inlet 120 can comprise one or more of sensor(s) 308, such as a flow meter 502 which can be utilized to measure flow of concentrated bleach (e.g., or another suitable acid or base) into the tank 102 (e.g., when filling the tank 102) and/or a concentration meter or concentration analyzer (e.g., concentration sensor 504 as later discussed in greater detail), which can be utilized to determine a concentration of an acid or base herein and/or a diluted mix herein. In various embodiments, the tank 102 can comprise a pump 124 which can pump concentrate into the tank 102 (e.g., via inlet 120) or out of the tank 102 (e.g., via pipe 110).

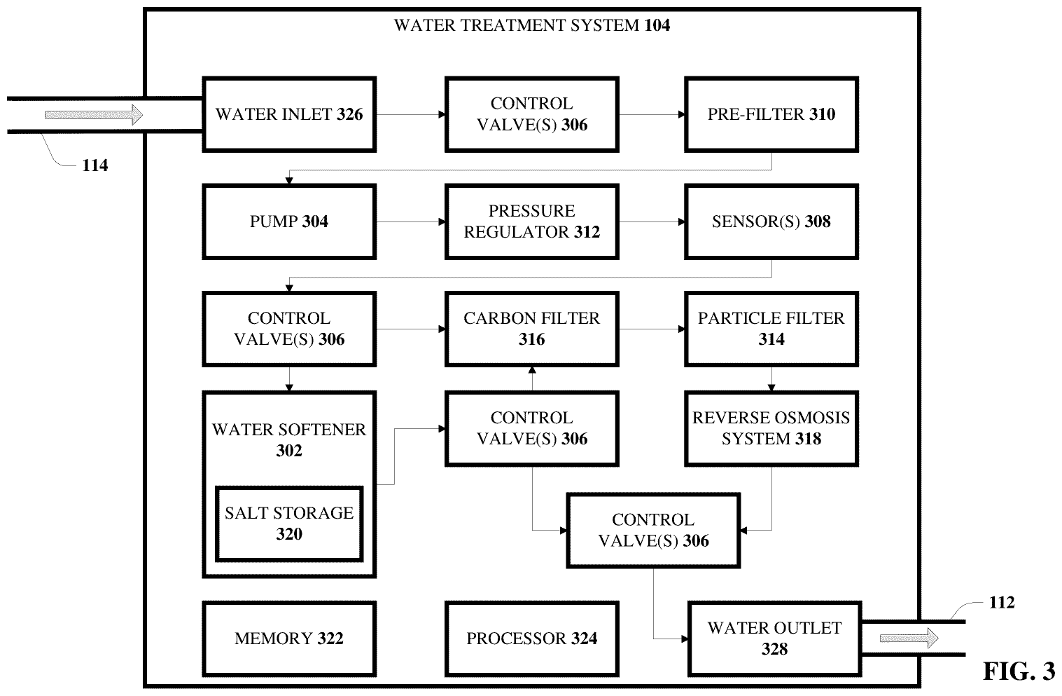

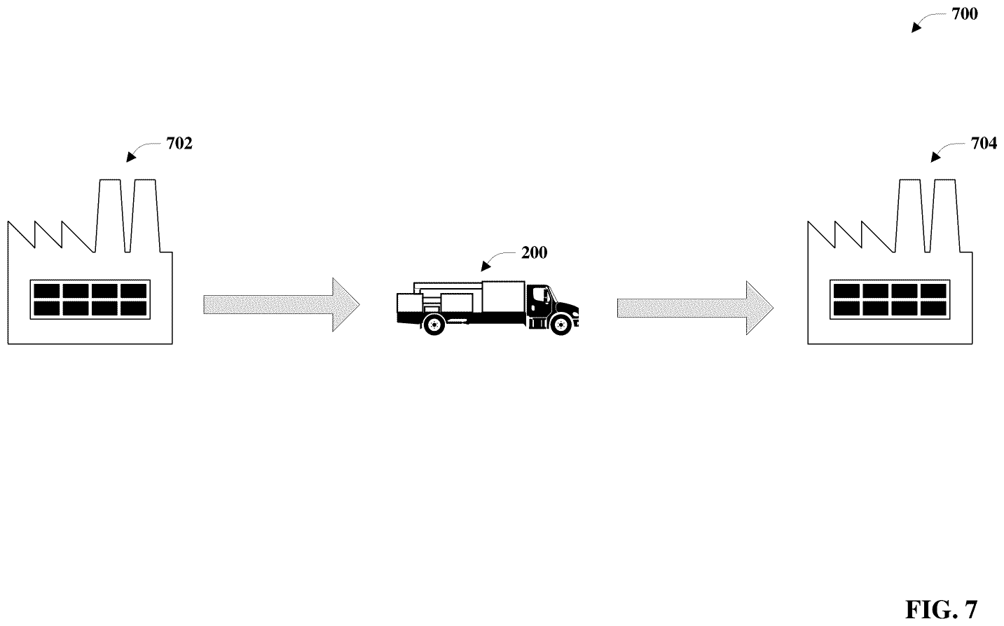

The water treatment system 104 can comprise one or more of a variety of components (additionally discussed with respect to FIG. 3). The water treatment system 104 (e.g., a water purification or conditioning system) can comprise and/or be fluidly connected to the water inlet 114. In various embodiments, the water inlet 114 can comprise a removable cap, funnel, and/or threaded fitting that can enable filling of or connection to the water treatment system 104 without spilling of liquids. In some embodiments, the water inlet 114 can comprise one or more of sensor(s) 308, such as a flow meter 502, which can be utilized to measure flow of raw water into the water treatment system 104. In various implementations, the water inlet 114 can comprise a raw water inlet that can intake raw water (e.g., untreated water) from an entity or facility (e.g., facility 704 later discussed in greater detail with respect to FIG. 7). The water treatment system 104 can treat and/or soften the untreated water, resulting in treated water, that can be output from the water treatment system 104 to the mixing system 106 (e.g., a mixer or a dilution system) via the pipe 112. For example, the water treatment system 104 can remove suspended solids, dissolved solids, and/or ions such as Mg, Ca, Sr, Ba, Al, Fc, Ni, Co, Cu, Cr, Co, Mn, Zn, heavy metals, etc. from raw water. It is noted that, in various embodiments, the water treatment system 104 and/or the mixing system 106 can comprise the pipe 112. In some embodiments, the pipe 112 can comprise one or more of sensor(s) 308, such as a flow meter 502, which can be utilized to measure flow of the treated water to the mixing system 106. It is additionally noted that the mixing system 106 can output a diluted mix (e.g., diluted mix of water and bleach, or another suitable dilution of an acid or base) via the diluted mix outlet 116, which can be a component or and/or fluidly connected to the mixing system 106. In various embodiments, the diluted mix outlet 116 can comprise a removable cap and/or threaded fitting that can enable connection (e.g., of a hose or pipe) to the mixing system 106 without spilling of liquids. In some embodiments, the diluted mix outlet 116 can comprise one or more of sensor(s) 308, such as a flow meter 502, which can be utilized to measure flow of the diluted mix out of the mixing system 106 (e.g., to a consumer facility). In various embodiments, a concentration of the diluted mix can range from approximately 8% to approximately 16%, though such concentrations are nonlimiting and other suitable concentrations of diluted mixes (e.g., of suitable acids or bases) herein are envisaged. According to an example, a nonlimiting defined concentration range of a diluted mix herein can comprise 12.5%-16%, or another suitable defined concentration range or defined concentration.

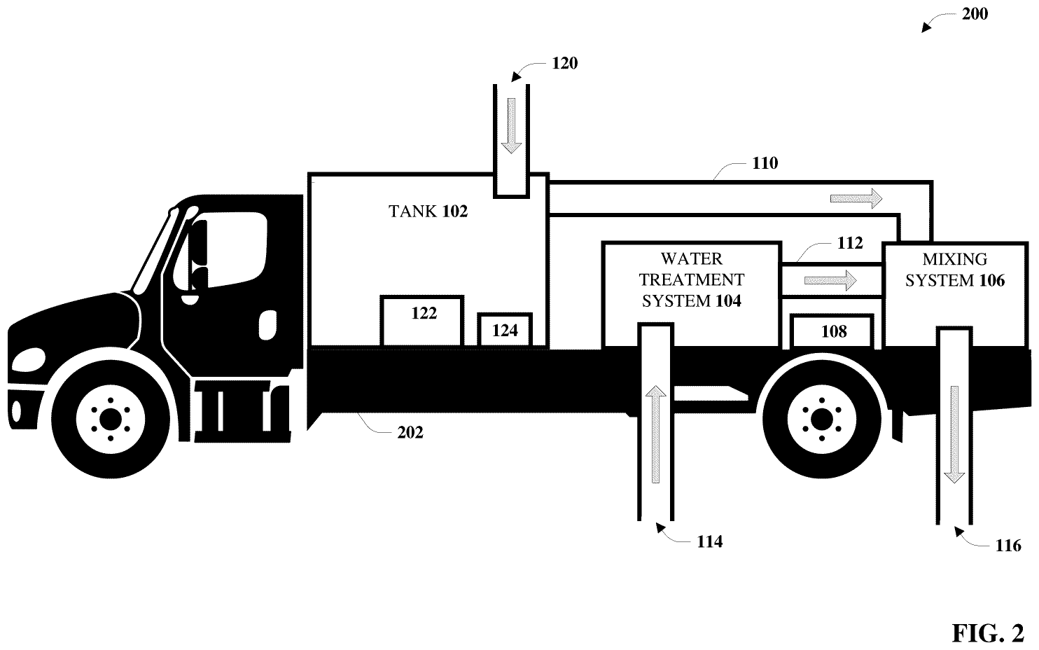

Turning now to FIG. 2, there is illustrated an example, non-limiting bleach dilution and delivery vehicle 200 in accordance with one or more embodiments herein. The bleach dilution and delivery vehicle 200 can be similar to bleach dilution and delivery vehicle 100 and/or comprise similar components. Repetitive elements or components and/or like descriptions thereof are omitted for sake of brevity. However, instead of comprising a trailer 118, the bleach dilution and delivery vehicle 200 can comprise a truck 202. In this regard, the truck 202 can comprise a self-propelled vehicle. It is noted that truck 202 can comprise any type of vehicle, such as a semi-trailer truck, internal combustion engine (ICE) vehicle, hybrid vehicle, plug-in hybrid electric vehicle (PHEV), electric vehicle (EV), autonomous vehicle, hydrogen fuel-cell vehicle, natural gas vehicle (NGV), or another suitable vehicle. In various embodiments, the truck 202 can additionally, or alternatively, comprise or be representative of other transportation mediums, such as nautical travel and respective vessels as boats, pontoons, fan boat, jet ski, ferry, water taxi, barge, tanker, sailboat, kayak, cruise ships, carriers, submarine, unmanned nautical vehicles, etc. Similarly, the truck 202 can additionally, or alternatively, comprise or be representative of air or space travel vehicles, such as airplanes, helicopters, drones, unmanned aerial vehicles, etc. In various embodiments, the trailer 118 and/or truck 202 can comprise a 12 volt electrical system, a 24 volt electrical system, a 400 volt electrical system, an 800 volt electrical system, or another suitable electrical system. The truck 202 can comprise one or more of a variety of materials, such as a metal (e.g., steel, aluminum, stainless steel, or another suitable metal), wood, composite materials, or other suitable material and/or a combination thereof. In various implementations, the truck 202 can comprise a protective coating (e.g., a corrosion resistant coating) to prevent damage from contact with materials transported by the truck 202 and/or from road debris or environmental conditions. In various implementations, the truck 202 can be configured to tow the trailer 118.

Turning now to FIG. 3, there is illustrated an example, non-limiting water treatment system 104 in accordance with one or more embodiments herein. Because concentrated bleach (e.g., 25% concentrated bleach or another suitable concentration) can be rendered unstable by certain temperatures or impurities of water used in dilution, the water treatment system 104 can be configured to treat raw water (e.g., from a facility 704) in order to supply treated water sufficient for use in the dilution of concentrated bleach or other suitable acids or bases. The water treatment system 104 can comprise one or more of a variety of components, such as a water softener 302, pump 304, control valve(s) 306, sensor(s) 308, pre-filter 310, pressure regulator 312, particle filter 314, carbon filter 316, reverse osmosis system 318, salt storage 320, memory 322, processor 324, water inlet 326, and/or water outlet 328. In various embodiments, one or more of the water softener 302, pump 304, control valve(s) 306, sensor(s) 308, pre-filter 310, pressure regulator 312, particle filter 314, carbon filter 316, reverse osmosis system 318, salt storage 320, water inlet 326, and/or water outlet 328 can be fluidly connected (e.g., via corresponding pipes) to one another.

In one or more embodiments, the water treatment system 104 can comprise a water softener 302. According to an embodiment, the water softener 302 can comprise any suitable type of water softener that can treat hard water (e.g., untreated water or raw water) by removing the minerals responsible for the hard water (e.g., through ion-exchange). Salt (e.g., solar salt, rock salt, evaporated salt, or another salt suitable for use in a water softener 302) utilized in the ion-exchange process can be stored in the salt storage 320 (e.g., if regeneration of the water softener 302 is needed, though regeneration can additionally, or alternatively, be facilitated at a home-base facility, such as a facility 702 later discussed in greater detail). In various embodiments, the water softener 302 can thus soften untreated water, resulting in the treated water.

The pump 304 can be utilized to pump liquid (e.g., untreated water or treated water) into and/or out of the water treatment system 104. The control valve(s) 306 and/or pump 304 can be utilized to control flow rates of liquid (e.g., untreated water or treated water) into and/or out of the water treatment system 104. The pre-filter 310 can comprise a filter that filters sediment, rust, sand, and/or other impurities from water from a facility (e.g., a facility 704 with respect to FIG. 7). The pressure regulator 312 can comprise a valve that controls the pressure of a liquid herein within or external to the water treatment system 104. The particle filter 314 can comprise a low-micron filter that filters low micron impurities from water that enters the water treatment system 104. The carbon filter 316 can comprise a carbon medium to adsorb molecules, atoms, and/or ions from water that enters the water treatment system 104. In some embodiments, the water treatment system 104 can comprise a reverse osmosis system 318. The reverse osmosis system 318 can comprise one or more partially permeable membranes to separate ions, unwanted molecules, and/or larger particles from water that enters the water treatment system 104. The water inlet 326 can be fluidly connected to and/or comprise the water inlet 114. Further, the water outlet 328 can be fluidly connected to and/or comprise the pipe 112.

It is noted that one of more of the control valve(s) 306 can be utilized in order to selectively direct water to, or divert water from, the water softener 302, reverse osmosis system 318, or another component of the water treatment system 104 (e.g., as controlled via the water control component 602 later discussed in greater detail). In this regard, the water treatment system 104 can selectively bypass the water softener 302 and/or reverse osmosis system 318.

Turning now to FIG. 4, there is illustrated an example, mixing system 106 (e.g., a mixer) in accordance with one or more embodiments herein. The mixing system 106 can be affixed to the bleach dilution and delivery vehicle 100 or bleach dilution and delivery vehicle 200, and can be configured to mix water and sodium hypochlorite to a defined strength, resulting in a diluted mix. The mixing system 106 can comprise one or more of a variety of components, such as concentrate inlet 402, pump 404, control valve(s) 406, sensor(s) 308, water inlet 408, processor 324, tank 410, mixer 412, memory 322, and/or outlet 414. In various embodiments, one or more of the concentrate inlet 402, pump 404, control valve(s) 406, sensor(s) 308, water inlet 408, tank 410, mixer 412, and/or outlet 414 can be fluidly connected (e.g., via corresponding pipes) to one another.

The concentrate inlet 402 can be fluidly connected to and/or comprise the pipe 110. The pump 404 can be utilized to pump liquid into and/or out of the mixing system 106. The control valve(s) 406 and/or pump 404 can be utilized to control flow rates of liquid (e.g., treated or untreated water, or a concentrated acid or base such as bleach) into and/or out of the mixing system 106 or into the tank 410. The water inlet 408 can be fluidly connected to and/or comprise the pipe 112. In various embodiments, the tank 410 can comprise a holding tank for holding a volume of a diluted mix (e.g., a mix treated or untreated water, and a concentrated acid or base such as bleach) herein. For instance, the tank 410 can be utilized in conjunction with one or more of the sensor(s) 308 in order to determine concentration of the diluted mix prior to dispensing via the outlet 414, which can comprise and/or be fluidly connected to the diluted mix outlet 116. In this regard, if a concentration of the diluted mix is not within a defined threshold, the diluted mix can be adjusted (e.g., by adding more water or adding more concentrated acid or base via the control valve(s) 406) prior to dispensing the diluted mix or while dispensing the diluted mix. In some embodiments, the mixing system 106 and/or tank 410 can comprise an mixer 412, which can be utilized to mix and/or agitate the concentrated bleach and water to achieve the diluted mix described herein. In other embodiments, the mixer 412 can comprise an inline mixer, which can be located before or after the tank 410, or in another suitable location.

Turning now to FIG. 5, there is illustrated example sensor(s) 308 in accordance with one or more embodiments herein. The sensor(s) 308 can comprise one or more of a flow meter 502, concentration sensor 504, temperature sensor 506, and/or level sensor 508. The flow meter 502 can comprise one or more of a Coriolis meter, differential pressure meter, magnetic (“mag”) meter, multiphase meter, ultrasonic meter, vortex meter, or another suitable flow meter that can be utilized to measure flow of liquids herein. In various embodiments, the bleach dilution and delivery vehicle 100 or the bleach dilution and delivery vehicle 200 can comprise a plurality of flow meters 502. For example, the bleach dilution and delivery vehicle 100 or bleach dilution and delivery vehicle 200 can comprise a first flow meter (e.g., located in the water treatment system 104, pipe 112, or mixing system 106) that determines water flow into the mixing system 106, a second flow meter (e.g., located in the tank 102, pipe 110, or mixing system 106) that determines acid or base (e.g., sodium hypochlorite) flow into the mixing system 106, and/or a third flow meter (e.g., located in the mixing system 106 or diluted mix outlet 116) that determines diluted mix flow out of the mixing system 106.

The concentration sensor 504 can comprise one or more of a variety of types of concentration sensors that measure a volume or concentration an acid or base herein (e.g., bleach), such as a pH sensor, conductivity sensor, specific gravity sensor, concentration analyzer, titration sensor, or another suitable type of concentration sensor, which can be utilized to determine a concentration of an acid or base herein and/or a diluted mix herein. The temperature sensor 506 can comprise one or more of a negative temperature coefficient thermistor type temperature sensor, a resistance temperature detector, a thermocouple, a semiconductor-based sensors, or another suitable temperature sensor that can be utilized to determine a temperature of various liquids herein. The level sensor 508 can comprise one or more of a variety of types of levels sensors that can be utilized to determine a level of a liquid in a tank herein (e.g., tank 102 or tank 410). Nonlimiting examples of such level sensors can comprise an optical level sensor, vibrating or tuning fork level sensor, ultrasonic level sensor, float switch level sensor, capacitance level sensor, radar level sensor, conductivity or resistance level sensor, or another suitable type of level sensor.

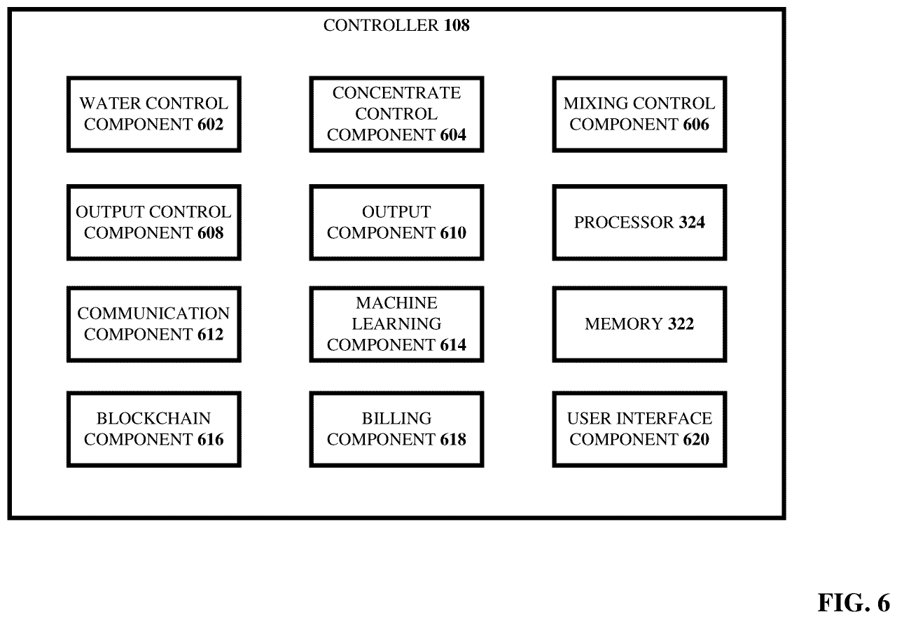

Turning now to FIG. 6, there is illustrated an example, controller 108 in accordance with one or more embodiments herein. The controller 108 can comprise a computerized tool, which can be configured to perform various operations relating to dilution of a water-based acid or base herein. The controller 108 can comprise one or more of a variety of components, such as water control component 602, concentrate control component 604, mixing control component 606, output control component 608, output component 610, processor 324, communication component 612, machine learning component 614, memory 322, blockchain component 616, billing component 618, and/or user interface component 620. In various embodiments, one or more of the memory 322, processor 324, water control component 602, concentrate control component 604, mixing control component 606, output control component 608, output component 610, communication component 612, machine learning component 614, blockchain component 616, billing component 618, and/or user interface component 620 can be communicatively or operably coupled (e.g., over a bus or wireless network) to one another to perform one or more functions of water treatment system 104, mixing system 106, sensor(s) 308, and/or controller 108.

According to an embodiment, the water control component 602 can control one or more functions applicable to the water treatment system 104. For instance, the water control component 602 can control various flow and/or filtering functions applicable to the water treatment system 104. In this regard, the water control component 602 can control one or more of the control valve(s) 306, pump 304, and/or pressure regulator 312 in order to regulate flow into or out of the water treatment system 104. Further, the water control component 602 can control one or more of the control valve(s) 306 or pump 304 in order to direct untreated water through one or more of the water softener 302, pre-filter 310, particle filter 314, carbon filter 316, reverse osmosis system 318, or another suitable component of the water treatment system 104. For instance, the water control component 602 can control the control valve(s) 306 in order to selectively direct water to, or divert water from, the water softener 302, reverse osmosis system 318, or another component of the water treatment system 104. In this regard, the water control component 602 can cause the water treatment system 104 to selectively bypass the water softener 302 and/or reverse osmosis system 318. Further, based on one or more readings from the sensor(s) 308, the water control component 602 can be configured to regulate flow of water via the water outlet 328 and into the mixing system 106.

According to an embodiment, the concentrate control component 604 can control one or more functions applicable to the tank 102 and/or associated components. Based on one or more readings from the sensor(s) 308, the concentrate control component 604 can be configured to regulate flow of bleach (e.g., or anther concentrate acid or bleach) via inlet 120 into the tank 102 and/or out of the tank 102 via pipe 110 into the mixing system 106 (e.g., by controlling the pump 124 and/or control valve(s) 406). For instance, the concentrate control component 604 can utilize a defined control algorithm to regulate the flow of bleach into the tank 102 and/or out of the tank 102 via pipe 110 into the mixing system 106. In another embodiment, the concentrate control component 604 can control a temperature control unit 122 of the tank 102 in order to maintain a defined temperature or temperature range of contents of the tank 102. For instance, the concentrate control component 604 can utilize a defined control algorithm to regulate the temperature of the contents of the tank 102 via the temperature control unit 122.

According to an embodiment, the mixing control component 606 can control one or more functions applicable to the mixing system 106. Based on one or more readings from the sensor(s) 308, the mixing control component 606 can be configured to regulate flow of bleach via concentrate inlet 402 and/or flow of water via water inlet 408 into the mixing system 106 by adjusting one or more of the control valve(s) 406 of the mixing system 106 (e.g., using a defined control algorithm). Further, the mixing control component 606 can control the mixer 412 and/or determine concentrations (e.g., using the sensor(s) 308) of diluted mix in the tank 410 and/or before/after the tank, depending on the location of the mixer 412 (e.g., the mixer 412 can be located before the tank 410, after the tank 410, and/or within the tank 410). In this regard, the mixing control component 606 can control the mixing system 106 to achieve a defined strength of the diluted mix described herein (e.g., using a defined control algorithm). Thus, the mixing control component 606 can adjust a first flow rate of the water and a second flow rate of the sodium hypochlorite, for instance, to achieve a defined concentration of the diluted mix described herein. In various embodiments, the mixing control component 606 can determine a mixing ratio of the sodium hypochlorite (e.g., or another suitable concentrated acid or base) and water based on, for instance, respective concentrations of the concentrated acid or base (e.g., determined via sensor 308) and the defined concentration of the diluted mix. The mixing control component 606 can then (e.g., based on the mixing ratio) control a mixing system 106 of the bleach dilution and delivery vehicle 100 or the bleach dilution and delivery vehicle 200 to mix the water and the concentrated acid or base (e.g., sodium hypochlorite) to the defined output strength (e.g., by weight or volume). The output control component 608 can be configured to regulate flow/dispensing of diluted mix via the outlet 414 by adjusting one or more of the control valve(s) 406 of the mixing system 106. In this regard, the output control component 608 can dispense a diluted mix in response to a dispensing condition being determined to be satisfied (e.g., by the output control component 608). Such a dispensing condition can comprise the diluted mix being determined (e.g., via a sensor 308) to comprise a defined concentration or be within a defined threshold of the defined concentration.

The output component 610 can be configured to generate and/or render an output corresponding to consumption of a concentrate (e.g., bleach) herein and/or output/dispensing of a diluted mix herein. In this regard, the output component 610 can generate an output based on the mixing (e.g., via the mixing control component 606 and/or mixing system 106) of the water and the concentrate (e.g., sodium hypochlorite) to a defined strength or concentration. For instance, the output component 610 can generate a printout (e.g., via a printer of the output component 610), such as a receipt comprising an indication of proof of custody transfer of the concentrate (e.g., bleach/sodium hypochlorite) and/or diluted mix. In another embodiment, the output component 610 can render (e.g., on a display device of the output component 610 or user interface component 620) a summary of consumption of concentrate herein and/or a summary of the output/dispensing of the diluted mix herein. In some embodiments, the communication component 612 can be utilized to transmit an output generated by the output component 610 (e.g., to a registered device associated with facility 702 and/or facility 704). For example, the communication component 612 can generate and send an email, text message, or other suitable electronic message indicative of consumption of concentrate herein and/or an electronic message indicative of the output/dispensing of the diluted mix herein. Further, the billing component 618 can generate a bill based on the consumption of concentrate herein and/or generate a bill based on the output/dispensing of the diluted mix herein. In this regard, the billing component 618 can generate a bill based on an amount of concentrate (e.g., sodium hypochlorite) consumed by the mixing system 106. In some embodiments, the billing component 618 can automatically bill an account registered with the controller 108. In other embodiments, the bill or invoice generated by the billing component 618 can be rendered via the output component 610, user interface component 620, and/or transmitted via the communication component 612 (e.g., to a device registered with the controller 108). It is noted that the communication component 612 can comprise the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, 6G, global system for mobile communications (“GSM”), code-division multiple access (“CDMA”), satellite, visual cues, radio waves, etc.)

In some embodiments, the controller 108 can comprise a machine learning component 614. The machine learning component 614 can perform one or more machine learning and/or artificial intelligence functions applicable to the controller 108, bleach dilution and delivery vehicle 100, and/or bleach dilution and delivery vehicle 200 described herein. According to an embodiment, the machine learning component 614 can generate a navigation model using machine learning based on past routes of the bleach dilution and delivery vehicle 100 or bleach dilution and delivery vehicle 200 and/or corresponding transit times or events (e.g., captured via a global positioning system sensor of the controller 108). This navigation model can be utilized in order to determine an optimal route that a bleach dilution and delivery vehicle 100 or bleach dilution and delivery vehicle 200 can travel based on one or more starting locations or destinations. According to another embodiment, the machine learning component 614 can generate a dilution model using machine learning based on past dilutions of acids or bases associated with the bleach dilution and delivery vehicle 100 or bleach dilution and delivery vehicle 200. This bleach dilution model can be utilized (e.g., via the mixing control component 606) to determine optimal control of one or more components (e.g., control valve(s) 406) of the mixing system 106. The dilution model can thus be utilized (e.g., by the controller 108) in order to increase accuracy of dilutions of acids or bases herein, reduce waste of acids or bases herein, and/or increase speed of dilutions described herein.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence model and/or machine learning or a machine learning model that can learn to perform the above or below described functions (e.g., via training using historical training data and/or feedback data).

In some embodiments, machine learning component 614 can comprise an artificial intelligence and/or machine learning model that can be trained (e.g., via supervised and/or unsupervised techniques) to perform the above or below-described functions using historical training data comprising various context conditions that correspond to various augmented network optimization operations. In this example, such an artificial intelligence and/or machine learning model can further learn (e.g., via supervised and/or unsupervised techniques) to perform the above or below-described functions using training data comprising feedback data, where such feedback data can be collected and/or stored (e.g., in memory) by the machine learning component 614. In this example, such feedback data can comprise the various instructions described above/below that can be input, for instance, to a system herein, over time in response to observed/stored context-based information.

Artificial intelligence and/or machine learning components herein can initiate an operation(s) associated with a based on a defined level of confidence determined using information (e.g., feedback data). For example, based on learning to perform such functions described above using feedback data, performance information, and/or past performance information herein, a machine learning component 614 herein can initiate an operation associated with determining various thresholds herein (e.g., a motion pattern thresholds, input pattern thresholds, similarity thresholds, authentication signal thresholds, audio frequency thresholds, or other suitable thresholds).

In an embodiment, the machine learning component 614 can perform a utility-based analysis that factors cost of initiating the above-described operations versus benefit. In this embodiment, the machine learning component 614 can use one or more additional context conditions to determine various thresholds herein.

To facilitate the above-described functions, a machine learning component 614 herein can perform classifications, correlations, inferences, and/or expressions associated with principles of artificial intelligence. For instance, the machine learning component 614 can employ an automatic classification system and/or an automatic classification. In one example, the machine learning component 614 can employ a probabilistic and/or statistical-based analysis (e.g., factoring into the analysis utilities and costs) to learn and/or generate inferences. The machine learning component 614 can employ any suitable machine-learning based techniques, statistical-based techniques and/or probabilistic-based techniques. For example, the machine learning component 614 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the machine learning component 614 can perform a set of machine-learning computations. For instance, the machine learning component 614 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

According to an embodiment, the blockchain component 616 can store various data elements associated with the controller 108, bleach dilution and delivery vehicle 100, or bleach dilution and delivery vehicle 200 to an immutable blockchain ledger. For example, the blockchain component 616 can write documentation data representative of the consumption of concentrate (e.g., bleach) herein or associated with output/dispensing of a diluted mix herein (e.g., volume or weight of concentrate or diluted mix) to an immutable blockchain ledger. Such documentation can comprise, for instance, a representation of proof of custody transfer of the concentrate (e.g., bleach/sodium hypochlorite) from one entity to another (e.g., from facility 702 to facility 704). Is it noted that the blockchain component 616 can write any data generated by the output component 610, billing component 618, or another component, device, controller, or system herein to an immutable blockchain ledger. According to an embodiment, the blockchain component 616 can record financial transactions (e.g., invoices, bills, payments, etc.) associated with the custody transfer of liquids herein.

According to an embodiment, the user interface component 620 can enable a user to view telemetry and/or status data associated with the controller 108, bleach dilution and delivery vehicle 100, or bleach dilution and delivery vehicle 200, and/or to control various aspects of system operation. The user interface component 620 can generate one or more display screens through which the user can interact with the controller 108, and thereby with respective controlled processes, components, and/or systems. Example display screens can visualize present states of the controller 108, bleach dilution and delivery vehicle 100, bleach dilution and delivery vehicle 200, and/or their associated devices or components, for instance, using graphical representations of the processes that display metered or calculated values, employ color or position animations based on state, render alarm notifications, or employ other such techniques for presenting relevant data to the user. The user interface component 620 can comprise fixed location or mobile devices with either user-installed or pre-installed operating systems, and either user-installed or pre-installed graphical application software. The user interface component 620 can communicatively interface with other devices or components herein over hardwired connections or over wired or wireless networks. For example, the user interface component 620 can be equipped with native hardwired inputs and outputs that communicate with other devices or components herein to facilitate control of those respective devices or components.

FIG. 7 illustrates an exemplary scenario 700 for water-based acid or base delivery and dilution using a bleach dilution and delivery vehicle in accordance with one or more embodiments described herein. The facility 702 (e.g., a first facility) can comprise a facility that stores a concentrate such as bleach, or another suitable concentrate. The facility 704 (e.g., a second facility) can comprise a consumer entity of a diluted mix. In various embodiments herein, the bleach dilution and delivery vehicle 100 or the bleach dilution and delivery vehicle 200 can be utilized to transport (e.g., via tank 102) a concentrate (e.g., concentrated bleach) from the facility 702 to the facility 704 (e.g., from a first location or first facility to a second location or second facility). Once at the facility 704, the bleach dilution and delivery vehicle 200 can mix (e.g., via mixing system 106) water from the facility 704 with bleach (e.g., or another suitable concentrate) stored on the bleach dilution and delivery vehicle 200 to a defined strength or concentration in order to supply a diluted mix to the facility 704. Once diluted, the bleach dilution and delivery vehicle 100 or the bleach dilution and delivery vehicle 200 can dispense (e.g., via mixing system 106) the diluted mix to the facility 704. In some embodiments, the bleach dilution and delivery vehicle 100 or the bleach dilution and delivery vehicle 200 can (e.g., prior to mixing the water with the sodium hypochlorite) soften or otherwise treat (e.g., using a water softener and/or water treatment system 104 of the bleach dilution and delivery vehicle 100 or the bleach dilution and delivery vehicle 200), untreated water from, the facility 704, resulting in treated water. In this regard, the bleach dilution and delivery vehicle 100 or the bleach dilution and delivery vehicle 200 can mix the treated water and concentrate (e.g., sodium hypochlorite) to a defined strength (e.g., via the mixing system 106).

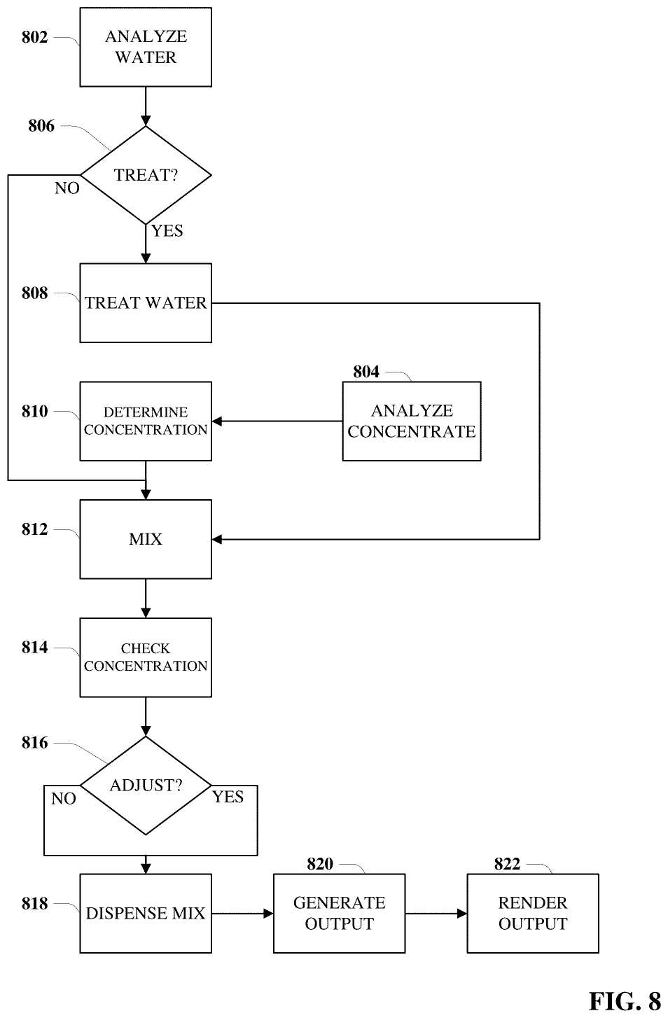

FIG. 8 is a flowchart of a process 800 associated with bleach (e.g., or other suitable concentrate) dilution and delivery using a bleach dilution and delivery vehicle in accordance with one or more embodiments described herein. At 802, water (e.g., from a facility 704) can be analyzed using one or more sensor(s) 308 (e.g., via the water control component 602). Various aspects (e.g., hardness, quantity or size of particulates, contaminants, etc.) of the water can be compared to various respective thresholds to determine whether treatment of the water is required. At 804, the bleach (or another suitable concentrate) can be analyzed, for instance, to determine a corresponding concentration (e.g., via the concentrate control component 604). For instance, a type and/or concentration of the concentrate stored in the tank 102 can be determined (e.g., by the concentrate control component 604 via sensor(s) 308). Further, a volume of the concentrate stored in the tank 102 can be determined (e.g., by the concentrate control component 604 via level sensor 508). At 806, if the water (e.g., from facility 704) needs to be treated (e.g., based on the analysis at 802), the process can proceed to 808. Otherwise, the process can proceed to 812. At 808, the water can be treated, for instance, via the water treatment system 104 and/or water control component 602. At 810, a defined concentration can be determined. This defined concentration can be predefined, input to via a user interface component 620, and/or communicated to the controller 108 via the communication component 612. At 812, the water and the concentrate (e.g., bleach) can be mixed (e.g., via the mixing system 106 and/or mixing control component 606), resulting in a diluted mix. At 814, a concentration of the diluted mix can be determined (e.g., by the mixing control component 606 via a concentration sensor 504 or another suitable sensor 308). At 816, if the diluted mix needs to be adjusted (e.g., concentration of diluted mix not equal to or within a defined threshold of the defined concentration), the adjustment to the diluted mix can be made while dispensing the diluted mix (e.g., via an in-line control valve 306 to correct the concentration while dispensing or by adjusting further dispensing to compensate for prior deviation from the defined concentration, such that the total volume of dispensed diluted mix results in the defined concentration), or in alternate embodiments, the process can return to 812 at which the mix ratio can be further adjusted (e.g., by the mixing system 106 and/or mixing control component 606). Otherwise, the process can proceed to 818. At 818, the diluted mix can be dispensed to the facility 704 (e.g., via the output component 610, diluted mix outlet 116, and/or outlet 414) in response to a dispensing condition being determined to be satisfied (e.g., by the output control component 608). Such a dispensing condition can comprise the diluted mix being determined (e.g., by the output control component 608, via a sensor 308) to comprise a defined or desired concentration or be within a defined threshold of the defined or desired concentration. At 820, an output representative of the dispensing of the diluted mix and/or consumption of bleach can be generated (e.g., via the output component 610). At 822, the output generated at 820 can be rendered via one or more suitable mediums. For instance, the output component 610 can generate a printout (e.g., via a printer of the output component 610), such as a receipt comprising an indication of proof of custody transfer of the concentrate (e.g., bleach/sodium hypochlorite). In another embodiment, the output component 610 can render (e.g., on a display device of the output component 610 or user interface component 620) a summary of consumption of concentrate herein and/or output/dispensing of the diluted mix herein.

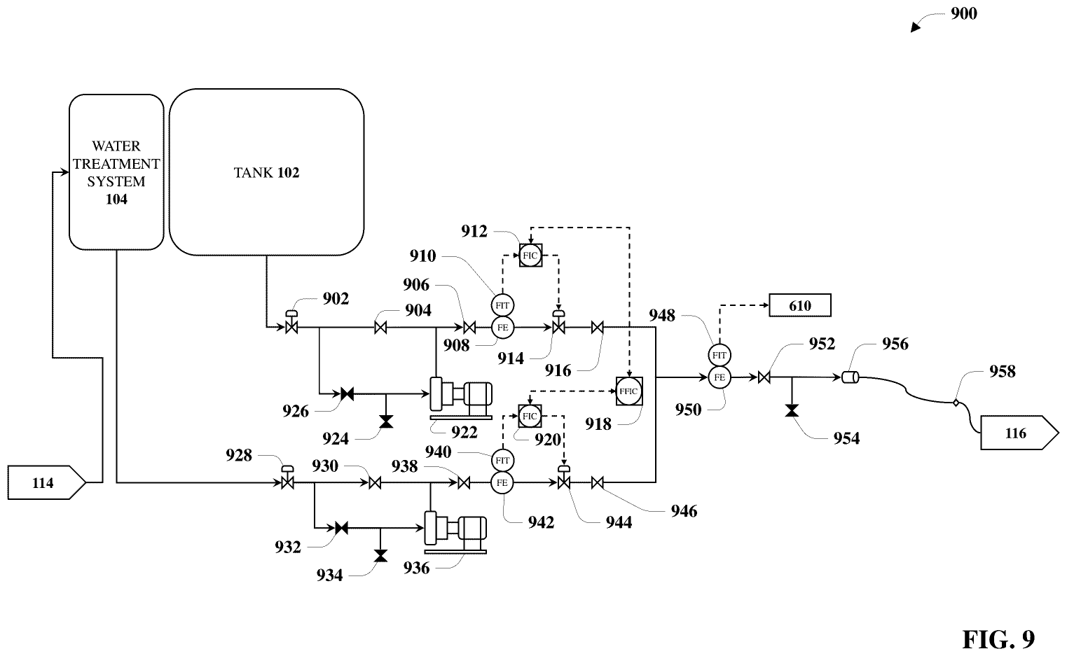

FIG. 9 is piping and instrumentation diagram 900 associated with bleach dilution and delivery (e.g., using a bleach dilution and delivery vehicle 100 or bleach dilution and delivery vehicle 200) in accordance with one or more embodiments described herein. For instance, the bleach dilution and delivery vehicle 100 or the bleach dilution and delivery vehicle 200 can comprise one or more of the tank 102, water treatment system 104, water inlet 114 (e.g., a raw water inlet), output component 610 (e.g., a printer), diluted mix outlet 116 (e.g., a client connection or facility connection), valve 902 (e.g., a pneumatic or diaphragm valve), valve 904 (e.g., a gate valve), valve 906 (e.g., a gate valve), flow element 908 (e.g., a flow sensor or flow meter), flow indicating transmitter 910, flow indicator and controller 912, valve 914 (e.g., a pneumatic or diaphragm valve), valve 916 (e.g., a gate valve), flow ratio indicator and controller 918, flow indicator and controller 920, pump 922, valve 924 (e.g., a drain), valve 926 (e.g., a gate valve), valve 928 (e.g., a pneumatic or diaphragm valve), valve 930 (e.g., a gate valve), valve 932 (e.g., a gate valve), valve 934 (e.g., a drain), pump 936, valve 938 (e.g., a gate valve), flow indicating transmitter 940, flow element 942 (e.g., a flow sensor or flow meter), valve 944 (e.g., a pneumatic or diaphragm valve), valve 946 (e.g., a gate valve), flow indicating transmitter 948, flow element 950 (e.g., a flow sensor or flow meter), valve 952 (e.g., a gate valve), valve 954 (e.g., a drain), adapter 956 (e.g., a hose adapter), and/or hose 958 (e.g., a flexible hose).

In various embodiments, one or more of the tank 102, water treatment system 104, water inlet 114 (e.g., a raw water inlet), output component 610 (e.g., a printer), diluted mix outlet 116 (e.g., a client connection), valve 902 (e.g., a pneumatic or diaphragm valve), valve 904 (e.g., a gate valve), valve 906 (e.g., a gate valve), flow element 908 (e.g., a flow sensor or flow meter), flow indicating transmitter 910, flow indicator and controller 912, valve 914 (e.g., a pneumatic or diaphragm valve), valve 916 (e.g., a gate valve), flow ratio indicator and controller 918, flow indicator and controller 920, pump 922, valve 924 (e.g., a drain), valve 926 (e.g., a gate valve), valve 928 (e.g., a pneumatic or diaphragm valve), valve 930 (e.g., a gate valve), valve 932 (e.g., a gate valve), valve 934 (e.g., a drain), pump 936, valve 938 (e.g., a gate valve), flow indicating transmitter 940, flow element 942 (e.g., a flow sensor or flow meter), valve 944 (e.g., a pneumatic or diaphragm valve), valve 946 (e.g., a gate valve), flow indicating transmitter 948, flow element 950 (e.g., a flow sensor or flow meter), valve 952 (e.g., a gate valve), valve 954 (e.g., a drain), adapter 956 (e.g., a hose adapter), and/or hose 958 (e.g., a flexible hose) can be fluidly and/or communicatively connected to one another (e.g., via suitable plumbing and/or electrical connection).

It is noted that various elements of the piping and instrumentation diagram 900 can comprise representations or implementations of one or more elements previously or later described herein. Repetitive elements or components and/or like descriptions thereof are omitted for sake of brevity. According to an embodiment, the control valve(s) 306 and/or control valve(s) 406 can comprise one or more of the valve 902, valve 904, valve 906, valve 914, valve 916, valve 924, valve 926, valve 928, valve 930, valve 932, valve 934, valve 938, valve 944, valve 946, valve 952, and/or valve 954. It is noted that one or more of the valve 902, valve 904, valve 906, valve 914, valve 916, valve 924, valve 926, valve 928, valve 930, valve 932, valve 934, valve 938, valve 944, valve 946, valve 952, and/or valve 954 can be controlled via the controller 108 (e.g., or via a component of the controller 108 or another suitable component or element herein). Further, the pump 304 and/or pump 404 can comprise one or more of the pump 922 and/or pump 936. It is also noted that one or more of the pump 922 and/or pump 936 can be controlled via the controller 108 (e.g., or via a component of the controller 108 or another suitable component or element herein). Additionally, sensor 308 and/or flow meter 502 can comprise one or more of the flow element 908, flow element 942, and/or flow element 950. In this regard, flow element 908 can determine flow (e.g., an amount of flow) of concentrate herein (e.g., bleach), the flow element 942 can determine flow (e.g., an amount of flow) of treated or conditioned water herein, and the flow element 950 can determine flow (e.g., an amount of flow) of diluted mix herein (e.g., a diluted concentrate). Moreover, the controller 108 and/or communication component 612 can comprise one or more of the flow indicating transmitter 910, flow indicating transmitter 940, and/or flow indicating transmitter 948. In this regard, the flow indicating transmitter 910 can transmit (e.g., wirelessly or by wire) flow determined by the flow element 908 to a suitable component or element herein (e.g., flow indicator and controller 912, flow ratio indicator and controller 918, concentrate control component 604, mixing control component 606, or another suitable component or element herein), the flow indicating transmitter 940 can transmit (e.g., wirelessly or by wire) flow determined by the flow element 942 to a suitable component or element herein (e.g., flow indicating transmitter 940, flow ratio indicator and controller 918, water control component 602, mixing control component 606, or another suitable component or element herein), and the flow indicating transmitter 948 can transmit (e.g., wirelessly or by wire) flow determined by the flow element 950 to a suitable component or element herein (e.g., flow indicating transmitter 948, flow ratio indicator and controller 918, mixing control component 606, or another suitable component or element herein).

In various embodiments, the controller 108 and/or corresponding components can comprise one or more of the flow indicator and controller 912 (e.g., concentrate control component 604 and/or mixing control component 606), flow indicator and controller 920 (e.g., water control component 602 and/or mixing control component 606), flow indicating transmitter 948 (e.g., mixing control component 606), and/or flow ratio indicator and controller 918 (e.g., mixing control component 606). In this regard, the flow indicator and controller 912 and/or the flow ratio indicator and controller 918 can control the valve 914 and/or valve 916, and the flow indicator and controller 920 and/or the flow ratio indicator and controller 918 can control the valve 944 and/or valve 946.

According to an embodiment, the valve 928 can regulate the flow of conditioned or treated water from the water treatment system 104. If sufficient water pressure from the water treatment system 104 exists, the treated water can flow through valve 930. If additional treated water pressure is needed (e.g., as determined via the controller 108), the valve 930 can be closed, valve 932 can be opened, and the pump 936 can be utilized to create additional pressure in the treated water line. In various embodiments, the valve 926 can be opened so that the corresponding line can be utilized when unloading the pump 922. Further, the valve 904 can be opened when the corresponding line is utilized with air padding. According to an embodiment, the flow ratio indicator and controller 918 (e.g., mixing control component 606) can control ratios of treated water and concentrate herein (e.g., bleach) via one or more corresponding valves upstream of the flow ratio indicator and controller 918. In various embodiments, the valve 952 can be opened (e.g., via control by the flow indicating transmitter 948 and/or the flow ratio indicator and controller 918) to enable flow of a diluted mix herein to a facility 704 (e.g., via the diluted mix outlet 116).

To enable connection to various connection types and sizes at a facility 704. the adapter 956 can be utilized to adapt various fittings of hose 958 to the bleach dilution and delivery vehicle 100 or the bleach dilution and delivery vehicle 200. In further embodiments, the adapter 956 can be located at an end of the hose 958 of the bleach dilution and delivery vehicle 100 or the bleach dilution and delivery vehicle 200 (e.g., to facilitate connection to a facility 704, which can comprise a variety of connections or fittings).

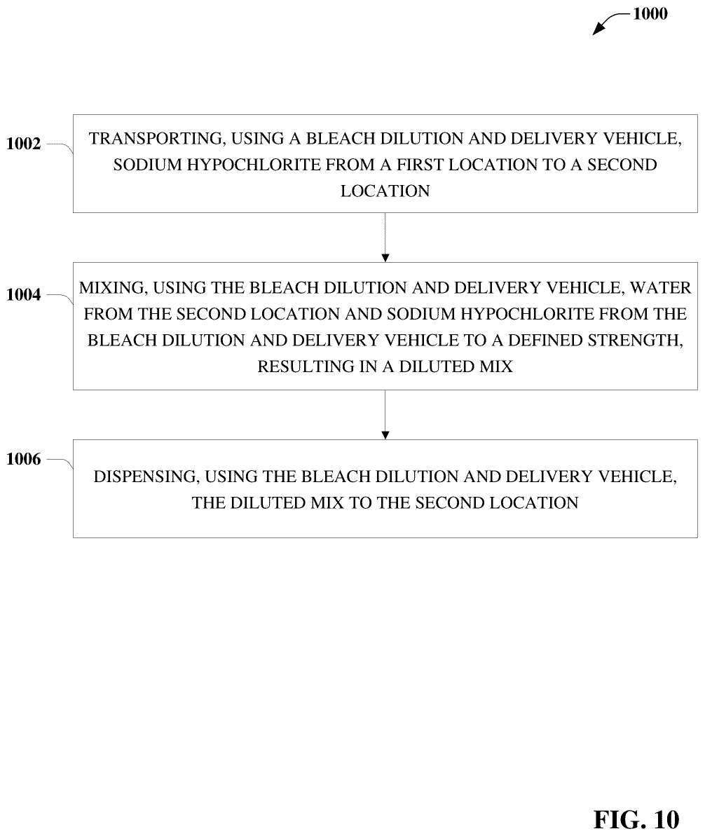

FIG. 10 is a block flow diagram for a process 1000 associated with bleach dilution and delivery using a bleach dilution and delivery vehicle in accordance with one or more embodiments described herein. At 1002, the process 1000 can comprise transporting, using a bleach dilution and delivery vehicle (e.g., bleach dilution and delivery vehicle 100 bleach dilution and delivery vehicle 200), sodium hypochlorite (e.g., or another suitable concentrate of acid or base) from a first location (e.g., facility 702) to a second location (e.g., facility 704). At 1004, the process 1000 can comprise mixing, using the bleach dilution and delivery vehicle (e.g., via the mixing system 106), water from the second location and sodium hypochlorite (e.g., or another suitable concentrate of acid or base) from the bleach dilution and delivery vehicle to a defined strength, resulting in a diluted mix. At 1006, the process 1000 can comprise dispensing, using the bleach dilution and delivery vehicle, the diluted mix to the second location.

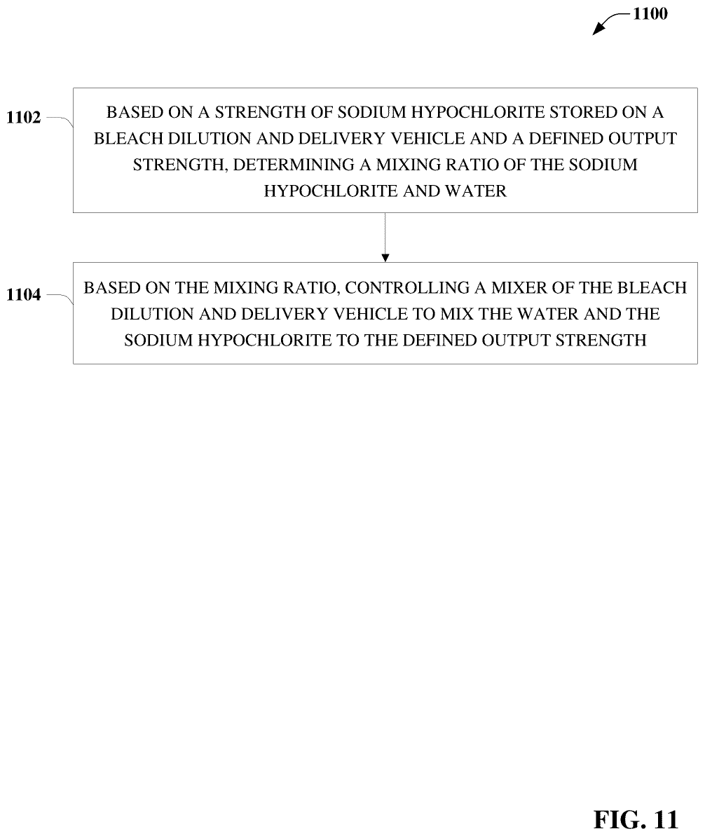

FIG. 11 is a block flow diagram for a process 1100 associated with bleach dilution and delivery using a bleach dilution and delivery vehicle in accordance with one or more embodiments described herein. At 1102, the process 1100 can comprise, based on a strength of sodium hypochlorite stored on a bleach dilution and delivery vehicle (e.g., bleach dilution and delivery vehicle 100 bleach dilution and delivery vehicle 200) and a defined output strength, determining a mixing ratio of the sodium hypochlorite (e.g., or another suitable concentrate of acid or base) and water. At 1104, the process 1100 can comprise, based on the mixing ratio, controlling (e.g., by the mixing control component 606) a mixer (e.g., mixing system 106) of the bleach dilution and delivery vehicle to mix the water and the sodium hypochlorite (e.g., or another suitable concentrate of acid or base) to the defined output strength (e.g., for the diluted mix).

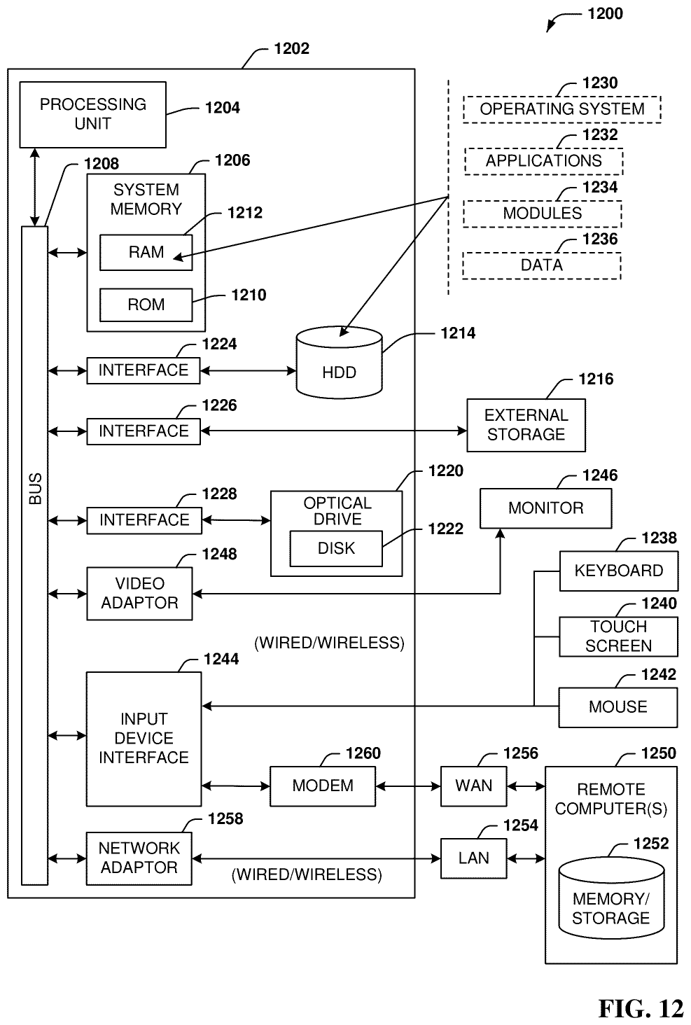

In order to provide additional context for various embodiments described herein, FIG. 12 and the following discussion are intended to provide a brief, general description of a suitable computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

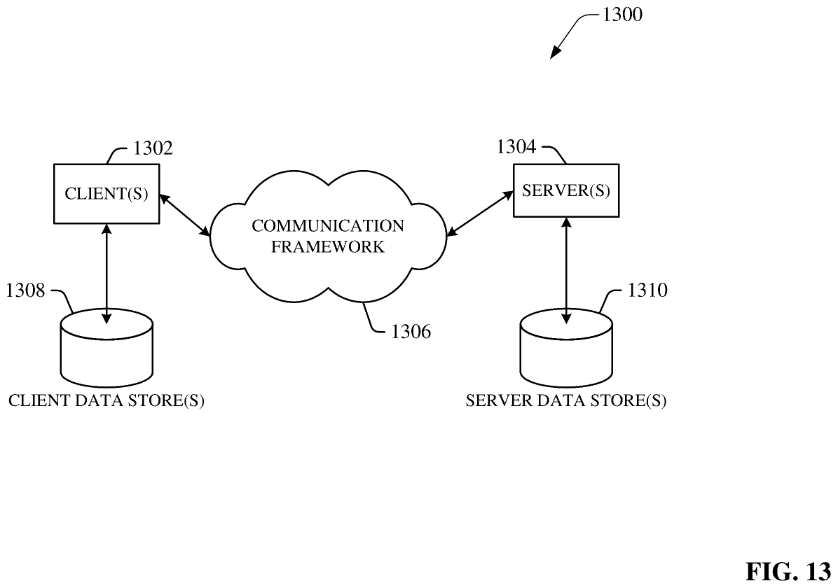

Referring now to FIG. 13, there is illustrated a schematic block diagram of a computing environment 1300 in accordance with this specification. The system 1300 includes one or more client(s) 1302, (e.g., computers, smart phones, tablets, cameras, PDA's). The client(s) 1302 can be hardware and/or software (e.g., threads, processes, computing devices). The client(s) 1302 can house cookie(s) and/or associated contextual information by employing the specification, for example.

The system 1300 also includes one or more server(s) 1304. The server(s) 1304 can also be hardware or hardware in combination with software (e.g., threads, processes, computing devices). The servers 1304 can house threads to perform transformations of media items by employing aspects of this disclosure, for example. One possible communication between a client 1302 and a server 1304 can be in the form of a data packet adapted to be transmitted between two or more computer processes wherein data packets may include coded analyzed headspaces and/or input. The data packet can include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

In one exemplary implementation, a client 1302 can transfer an encoded file, (e.g., encoded media item), to server 1304. Server 1304 can store the file, decode the file, or transmit the file to another client 1302. It is noted that a client 1302 can also transfer uncompressed file to a server 1304 and server 1304 can compress the file and/or transform the file in accordance with this disclosure. Likewise, server 1304 can encode information and transmit the information via communication framework 1306 to one or more clients 1302.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A bleach dilution and delivery vehicle, comprising:
a vehicle; and
a mixer affixed to the vehicle that mixes water and sodium hypochlorite to a defined strength, resulting in a diluted mix.

2. The bleach dilution and delivery vehicle of claim 1, wherein the vehicle comprises a trailer, and wherein the trailer comprises an unpowered vehicle.

3. The bleach dilution and delivery vehicle of claim 1, wherein the vehicle comprises a self-propelled vehicle.

4. The bleach dilution and delivery vehicle of claim 1, further comprising:
a first flow meter, wherein the first flow meter determines water flow into the mixer;
a second flow meter, wherein the second flow meter determines sodium hypochlorite flow into the mixer; and
a third flow meter, wherein the third flow meter determines diluted mix flow out of the mixer.

5. The bleach dilution and delivery vehicle of claim 1, wherein the water comprises treated water, and wherein the bleach dilution and delivery vehicle further comprises:
a water treatment system that removes suspended solids, dissolved solids, and ions from untreated water, or softens the untreated water, resulting in the treated water.

6. The bleach dilution and delivery vehicle of claim 1, further comprising:
a controller, comprising a processor, that controls the mixer to achieve the defined strength of the diluted mix, wherein controlling the mixer comprises adjusting a first flow rate of the water and a second flow rate of the sodium hypochlorite.

7. The bleach dilution and delivery vehicle of claim 6, wherein the controller further generates an output based on the mixing of the water and the sodium hypochlorite to the defined strength.

8. The bleach dilution and delivery vehicle of claim 7, wherein the output comprises a receipt comprising an indication of custody transfer of the sodium hypochlorite.

9. The bleach dilution and delivery vehicle of claim 6, wherein the controller further generates a bill based on an amount of the sodium hypochlorite consumed by the mixer.

10. The bleach dilution and delivery vehicle of claim 1, wherein a strength of the sodium hypochlorite comprises 5% to 35% sodium hypochlorite by weight.

11. The bleach dilution and delivery vehicle of claim 1, wherein the defined strength of the diluted mix is approximately 12.5% sodium hypochlorite by weight.

12. The bleach dilution and delivery vehicle of claim 1, further comprising:
a tank affixed to the vehicle that stores the sodium hypochlorite.

13. A method, comprising:
transporting, using a bleach dilution and delivery vehicle, sodium hypochlorite from a first location to a second location;
mixing, using the bleach dilution and delivery vehicle, water from the second location and the sodium hypochlorite from the bleach dilution and delivery vehicle to a defined strength, resulting in a diluted mix; and
dispensing, using the bleach dilution and delivery vehicle, the diluted mix to the second location.

14. The method of claim 13, wherein the water from the second location comprises untreated water, and wherein the method further comprises:
prior to mixing the water with the sodium hypochlorite, treating, using a water treatment system of the bleach dilution and delivery vehicle, the untreated water, resulting in treated water, wherein the treating comprises removing suspended solids, dissolved solids, and ions from the untreated water, and wherein mixing the water and the sodium hypochlorite to the defined strength comprises mixing the treated water and the sodium hypochlorite to the defined strength.

15. The method of claim 13, wherein a strength of the sodium hypochlorite comprises at least 25% sodium hypochlorite by weight.

16. The method of claim 13, wherein the defined strength of the diluted mix is approximately 12.5% to 16% sodium hypochlorite by weight.

17. The method of claim 13, wherein the sodium hypochlorite is stored in a tank affixed to the bleach dilution and delivery vehicle.

18. A non-transitory machine-readable medium, comprising executable instructions that, when executed by a processor, facilitate performance of operations, comprising:
based on a strength of sodium hypochlorite stored on a bleach dilution and delivery vehicle and a defined output strength, determining a mixing ratio of the sodium hypochlorite and water; and
based on the mixing ratio, controlling a mixer of the bleach dilution and delivery vehicle to mix the water and the sodium hypochlorite to the defined output strength.

19. The non-transitory machine-readable medium of claim 18, wherein the strength of the sodium hypochlorite comprises at least 25% sodium hypochlorite by weight.

20. The non-transitory machine-readable medium of claim 18, wherein the defined output strength is approximately 12.5% sodium hypochlorite by weight.
